(19) United States
(12) Patent Application Publication
(10) Pub. No.: US 2015/0063574 A1
(43) Pub. Date: Mar. 5, 2015

(54) APPARATUS AND METHOD FOR SEPARATING MULTI-CHANNEL AUDIO SIGNAL

(71) Applicant: Electronics and Telecommunications Research Institute, Daejeon (KR)

(72) Inventors: Keunwoo CHOI, Daejeon (KR); Tae Jin PARK, Daejeon (KR); Jae Hyoun YOO, Daejeon (KR); Jeong Il SEO, Daejeon (KR); Dae Young JANG, Daejeon (KR); Kyeong Ok KANG, Daejeon (KR); Jin Woong KIM, Daejeon (KR)

(73) Assignee: Electronics and Telecommunications Research Institute, Daejeon (KR)

(21) Appl. No.: 14/472,634

(22) Filed: Aug. 29, 2014

(30) Foreign Application Priority Data
Aug. 30, 2013 (KR) 10-2013-0103945

(51) Int. Cl. H04S 5/00

(52) U.S. Cl. CPC H04S 5/00; H04S 2400/01
USPC 381/18

(57) ABSTRACT

An apparatus and method for separating a multi-channel audio signal that separates a multi-channel audio signal into a plurality of sound source objects is disclosed, the apparatus including a multi-channel stereo transformer to transform a multi-channel audio signal into a plurality of stereo signals, and a stereo sound source separator to separate the plurality of stereo signals into a plurality of sound source objects.

### CROSS-REFERENCE TO RELATED APPLICATION

This application claims the priority benefit of Korean Patent Application No. 10-2013-0103945, filed on Aug. 30, 2013, in the Korean Intellectual Property Office, the disclosure of which is incorporated herein by reference.

### BACKGROUND

1. Field of the Invention

The present invention relates to an apparatus and method for separating a multi-channel audio signal that outputs a sound source object by separating a multi-channel audio signal.

2. Description of the Related Art

A multi-channel sound refers to an audio signal including more than three multi-channels or a system for playing such an audio signal, and differs from a single-channel mono channel audio or a two-channel stereo channel audio. A configuration of a 5.1 channel or a 7.1 channel is commonly used based on the multi-channel sound particularly in film contents.

Sound source separation refers to a technology for separating various constituents included in an audio signal from the audio signal. For example, in the sound source separation, a voice of differing speakers is separated from a voice signal, or a plurality of instrument signals is separated from a music signal. The sound source separation technology may be utilized in various manners. As an example, a sound of a predetermined speaker or musical instrument is intensified or suppressed through the sound source separation, and a separated signal may be used for sound recognition, automatic in-house newsletters, or karaoke services.

### SUMMARY

According to an aspect of the present invention, there is provided an apparatus for separating a multi-channel audio signal, the apparatus including a multi-channel-stereo transformer to transform a multi-channel audio signal into a plurality of stereo signals, and a stereo sound source separator to separate the plurality of stereo signals into a plurality of sound source objects.

The multi-channel-stereo transformer may include a time-frequency transformer to transform the multi-channel audio signal into a time-frequency region, a cross correlation coefficient calculator to calculate a cross correlation coefficient of a TF bin in the multi-channel audio signal transformed into the time-frequency region, a mask determiner to determine a mask to be applied to the multi-channel audio signal transformed into the time-frequency region based on the cross correlation coefficient, and a stereo signal generator to generate a stereo signal through use of the mask.

According to an aspect of the present invention, there is provided a method of separating a multi-channel audio signal, the method including transforming a multi-channel audio signal into a plurality of stereo signals, and separating the plurality of stereo signals into a plurality of sound source objects.

The transforming may include transforming the multi-channel audio signal into the signal of the time-frequency region, calculating a cross correlation coefficient of the TF bin in the multi-channel audio signal transformed into the signal of the time-frequency region, determining a mask to be applied to the multi-channel audio signal transformed into the signal of the time-frequency region based on the cross correlation coefficient, and generating a stereo signal through use of the mask.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of an apparatus for separating a multi-channel audio signal according to an embodiment of the present invention;

FIG. 2 is a diagram illustrating an operation of a multi-channel-stereo transformer according to an embodiment of the present invention;

FIG. 3 is a diagram illustrating an operation of a stereo sound source separator according to an embodiment of the present invention;

FIG. 4 is a diagram illustrating a configuration of a multi-channel-stereo transformer according to an embodiment of the present invention; and

FIG. 5 is a diagram illustrating an operation of a method of separating a multi-channel audio signal according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

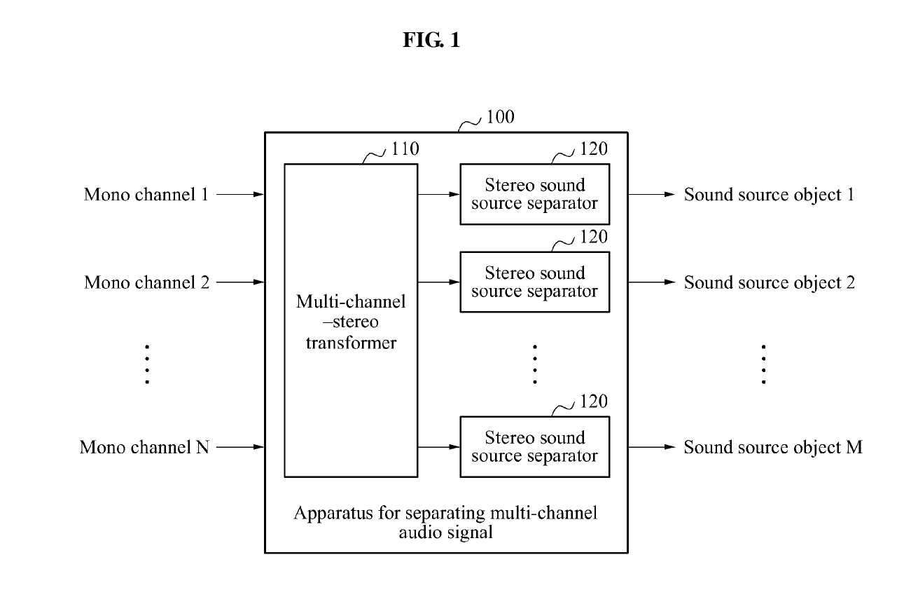

FIG. 1 is a diagram illustrating a configuration of an apparatus 100 for separating a multi-channel audio signal according to an embodiment of the present invention.

The apparatus 100 for separating the multi-channel audio signal may separate a sound source of a multi-channel audio signal based on sound source separation of a stereo signal. For example, when the apparatus 100 for separating the multi-channel audio signal receives an input of a multi-channel audio signal including “N” number of mono channels, the apparatus 100 for separating the multi-channel audio signal may separate the multi-channel audio signal into “M” number of sound source objects.

The multi-channel audio signal refers to an audio signal including more than three multi-channels. The stereo signal refers to an audio signal including two channels. A sound source refers to an audio signal prior to being mixed. For example, in an instance of a music signal generated through differing instrument sounds being mixed, a sound source may correspond to an instrument sound prior to being mixed. A channel signal refers to an audio signal on which mixing is completed.

Referring to FIG. 1, the apparatus 100 for separating the multi-channel audio signal includes a multi-channel-stereo transformer 110 and a stereo sound source separator 120.

The multi-channel-stereo transformer 110 may transform a multi-channel audio signal into a plurality of stereo signals. The multi-channel-stereo transformer 110 may transform the multi-channel audio signal into a matrix in a time-frequency dimension through time-frequency transform, and based on a time-frequency (TF) bin indicating a matrix element, calculate a cross correlation coefficient. The multi-channel-stereo transformer 110 may determine a mask indicating an audio channel pair to which a plurality of TF bins corresponding to, based on the cross correlation coefficient, and generate a stereo signal by applying the mask to the multi-channel audio signal transformed into a time-frequency region.

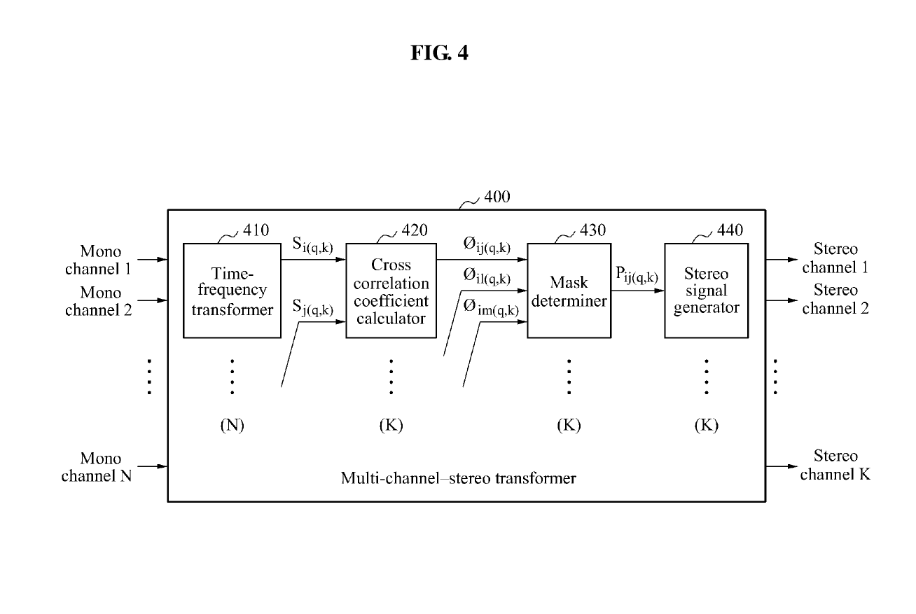

An operation of the multi-channel-stereo transformer 110 will be described later with reference to FIG. 4.

The stereo sound source separator 120 may separate the stereo signal output from the multi-channel-stereo transformer 110 into a plurality of sound source objects. The apparatus 100 for separating the multi-channel audio signal includes a plurality of stereo sound source separators 120.

For example, the stereo sound source separator 120 may separate the stereo signal into the plurality of sound source objects based on space filtering. The stereo sound source separator 120 may calculate power of a channel signal for a plurality of sub-bands from the stereo signal distinguished in a plurality of sub-band units, and based on the calculated power of the channel signal for the plurality of sub-bands, detect a position of a sound source. The stereo sound source separator 120 may calculate a cross correlation value between channels from the stereo signal distinguished in the plurality of sub-bands, and separate the stereo signal into the plurality of sound source objects based on space filtering using the detected sound source position and the calculated cross correlation value between channels.

For another example, the stereo sound source separator 120 may separate the sound source based on a model of an environment in which a signal is mixed and a statistical property of a sound source. Alternatively, the stereo sound source separator 120 may separate a stereo signal into sound source objects based on a time or frequency property unique to a sound source or based on information about a position of a sound source.

A configuration of the stereo sound source separator 120 may not be limited to the exemplary embodiment described above, and the stereo sound source separator 120 may separate a stereo signal into a plurality of sound source objects based on a method of separating a sound source of a stereo signal used in fields of related technology.

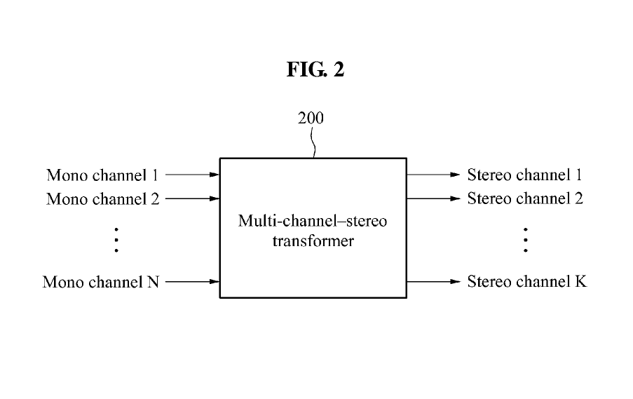

FIG. 2 is a diagram illustrating an operation of a multi-channel-stereo transformer 200 according to an embodiment of the present invention.

The multi-channel-stereo transformer 200 may transform a multi-channel audio signal into a stereo signal and output a result of the transformation.

When a multi-channel audio signal having “N” number of channels is included in the multi-channel-stereo transformer 200, a number of stereo signals output by the multi-channel-stereo transformer 200 may be determined based on Equation 1.

$${}_{N}^{}{C}{}_{2}^{} = \frac{N ( N - 1 )}{2} \qquad [ Equation 1 ]$$

In Equation 1, each stereo signal includes two channels, and a total of stereo signals includes “N(N−1)” number of channels. Hereinafter, _{N}C₂ of Equation 1 is assumed to be “K”.

For example, in a case of an audio signal of a 5.1 channel (N=5), the multi-channel-stereo transformer 200 may transform the audio signal of the 5.1 channel into 10 stereo signals to output. When two adjacent channels are grouped from among five channels of L, R, C, Ls, and Rs of a 5.1 channel, five combinations of (L-C), (C-R), (R-Rs), (Rs-Ls), and (Ls-L) may be possible. Also, in a case of (L-R), (L-Rs), (C-Rs), (C-Ls), and (R-Ls) in which non-adjacent channels are grouped, a combination (K=10) of “10” stereo signals is possible in the audio signal of the 5.1 channel.

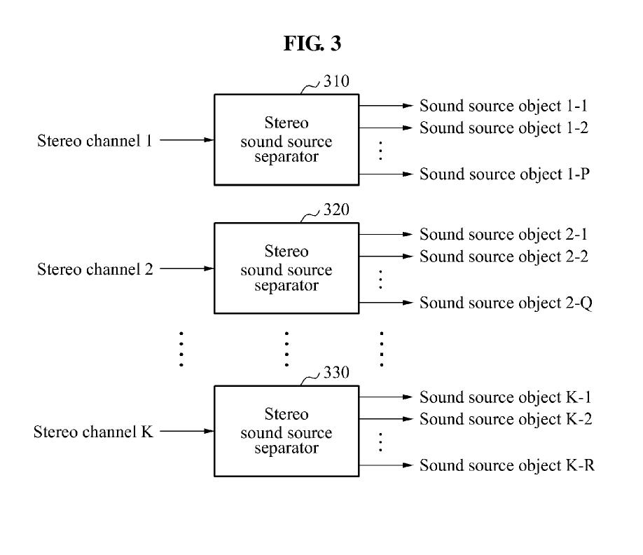

FIG. 3 is a diagram illustrating an operation of stereo sound source separators 310, 320, and 330, and a plurality of stereo channels input to the stereo sound source separators 310, 320, and 330 being separated into a plurality of sound source objects according to an embodiment of the present invention.

The stereo sound source separators 310, 320, and 330 may separate a stereo signal into a plurality of sound source objects based on space filtering, a statistical property of a sound source, a unique time of a sound source, a frequency property of a sound source, and information about a position of a sound source. Additionally, the stereo sound source separators 310, 320, and 330 may separate the stereo signal into the plurality of sound source objects based on a sound source separation technology used in fields of related technology.

A plurality of stereo channel signals output from the multi-channel-stereo transformer 100 of FIG. 1 may be input to each of the stereo sound source separators 310, 320, and 330. Each of the stereo sound source separators 310, 320, and 330 may separate the stereo channel signals input into the plurality of sound source objects.

FIG. 4 is a diagram illustrating a configuration of a multi-channel-stereo transformer 400 according to an embodiment of the present invention.

The multi-channel-stereo transformer 400 includes a time-frequency transformer 410, a cross correlation coefficient calculator 420, a mask determiner 430, and a stereo signal generator 440.

The time-frequency transformer 410 may transform a multi-channel audio signal into a time-frequency region through time-frequency transform. The time-frequency transform refers to transforming a one-dimensional (1D) audio signal into a two-dimensional (2D) time-frequency axis. The time-frequency transformer 410 performs the time-frequency transform, such as short-time Fourier transform (STFT) in which Fourier transform is performed in a frame unit, modified discrete cosine transform (MDCT), or wavelet transform.

For example, when the time-frequency transformer 410 uses STFT, a multi-channel audio signal may be separated into a plurality of intervals through use of a window function in a predetermined size, Fourier transform may be performed for the plurality of separated intervals, and a frequency component based on a time of the multi-channel audio signal may be obtained.

For another example, the time-frequency transformer 410 may transform an input signal, for example, “N” number of channel signals s[n], into a signal S(q, k) of a time-frequency region through time-frequency transform. S(q, k) denotes a 2D matrix of a time-by-frequency. In this example, “q” denotes a time index and “k” denotes a frequency index. “i” and “j” indicated as subscripts in output signals, for example, Sᵢ(q, k), Sⱼ(q, k), and the like, of the time-frequency transformer 410 denote an index of a channel.

The cross correlation coefficient calculator 420 may calculate a cross correlation coefficient of a plurality of TF bins with respect to a total of “K” number of audio channel pairs in the multi-channel audio signal transformed into the signal of the time-frequency region. Here, “K” corresponds to “K” of Equation 1. A TF bin refers to a plurality of elements of S(q, k), for example, Sᵢ(q, k), Sⱼ(q, k), and the like.

For example, the cross correlation coefficient calculator 420 may calculate a cross correlation coefficient φᵢⱼ(q, k) based on Equation 2.

φᵢⱼ(q,k)=λSᵢ(q,k)S*ⱼ(q,k)+(1−λ)φᵢⱼ(q−1,k) [Equation 2]

In Equation 2, λ denotes a forgetting factor, and reflects a temporal change. The cross correlation coefficient calculator 420 may not reflect the temporal change by setting a value of the forgetting factor λ to “0”. The value of the forgetting factor λ is in a range of 0≦λ≦1. Accordingly, the cross correlation coefficient calculator 420 may calculate the “K” number of cross correlation coefficients.

The mask determiner 430 may determine a mask to be applied to the multi-channel audio signal transformed into the signal of the time-frequency region based on a cross correlation coefficient. The mask determiner 430 may compare a plurality of audio channel pairs, and determine a mask Pᵢⱼ(q, k) indicating an audio channel pair to which a TF bin corresponding to. For example, when a number of audio channel pairs including an “i”-th channel is three, for example, (i-j), (i-k), and (i-m), the mask determiner 430 may compare cross correlation coefficients of the three audio channel pairs.

The mask determiner 430 may determine a mask “P” based on the following two methods.

### First Exemplary Embodiment

### Hard Thresholding

In a first exemplary embodiment, the mask determiner 430 may set a value of a mask corresponding to a greatest cross correlation coefficient to “1”, and set a value of a mask corresponding to other cross correlation coefficients to “0” from among cross correlation coefficients of an audio channel pair including a predetermined channel. A value of the mask “P” may be set to be “0”, “1”, or a discontinuous value. For example, the mask determiner 430 may select a greatest value from among cross correlation coefficients φᵢⱼ(q, k), φᵢₖ(q, k), and φᵢₘ(q, k). Subsequently, the mask determiner 430 may set the value of the mask corresponding to the greatest cross correlation coefficient to “1”, and set the values of the other masks to “0”. For example, when the cross correlation coefficient φᵢₖ(q, k) is greatest, a mask corresponding to φᵢⱼ(q, k) may be set to “1”, and masks Pᵢⱼ(q, k) and Pᵢₘ(q, k) respectively corresponding to φᵢₖ(q, k) and φᵢₘ(q, k) may be set to “0”.

### Second Exemplary Embodiment

### Soft Thresholding

In a second exemplary embodiment, the mask determiner 430 may set a value of a mask to a continuous value between “0” and “1” based on a size of the cross correlation coefficients of the audio channel pair including the predetermined channel. The value of the mask “P” may be set to be the continuous value between “0” and “1”. The mask determiner 430 may determine a value of a mask P(q, k) in association with a size of φ(q, k) on a corresponding channel. For example, the mask determiner 430 may determine Pᵢₖ(q, k), Pᵢⱼ(q, k), and Pᵢₘ(q, k) proportional to the size of φ(q, k), and also satisfying “Pᵢₖ(q, k)+Pᵢⱼ(q, k)+Pᵢₘ(q, k)=1”.

The stereo signal generator 440 may generate a stereo signal by applying the mask determined by the mask determiner 430 to the multi-channel audio signal transformed into the time-frequency region. The stereo signal generator 440 may generate the stereo signal through use of the TF bin of the multi-channel audio signal transformed into the signal of the time-frequency region and a mask corresponding to the TF bin.

For example, when Pᵢⱼ(q, k) is set to “1”, Sᵢ(q, k) and Sⱼ(q, k), for example, TF bins of an “i”-th channel and a “j”-th channel, are combined and generated into a single stereo signal. In this example, a left/right channel of the generated stereo signal may include [Sᵢ(q, k)Pᵢⱼ(q, k), Sⱼ(q, k)Pᵢⱼ(q, k)].

Through such a process, the multi-channel-stereo transformer 400 may transform “N” number of multi-channels audio signals into “K” number of stereo channel signals.

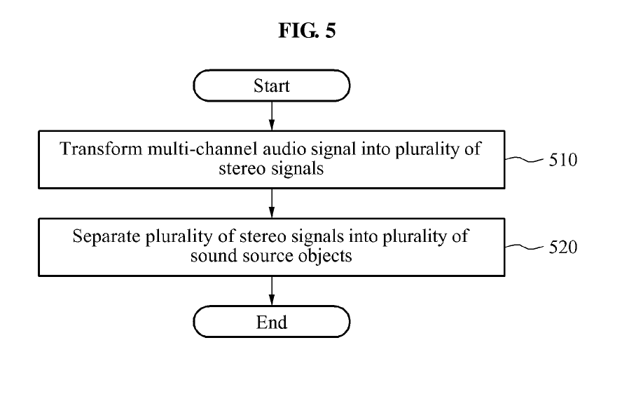

FIG. 5 is a diagram illustrating an operation of a method of separating a multi-channel audio signal according to an embodiment of the present invention. In operation 510, an apparatus for separating a multi-channel audio signal may transform a multi-channel audio signal into a plurality of stereo signals. The apparatus for separating the multi-channel audio signal may transform the multi-channel audio signal into a signal of a time-frequency region through time-frequency transform, and calculate a cross correlation coefficient of a TF bin in the multi-channel audio signal transformed into the signal of the time-frequency region. The apparatus for separating the multi-channel audio signal may calculate the cross correlation coefficient based on a forgetting factor for reflecting a temporal change and the TF bin. The apparatus for separating the multi-channel audio signal may determine a mask to be applied to the multi-channel audio signal transformed into the signal of the time-frequency region based on the cross correlation coefficient, and generate a stereo signal through use of the mask. The apparatus for separating the multi-channel audio signal may generate the stereo signal through use of the TF bin of the multi-channel audio signal transformed into the signal of the frequency region, and the mask corresponding to the TF bin.

In operation 520, the apparatus for separating the multi-channel audio signal may separate a stereo signal output from a multi-channel-stereo transformer into a plurality of sound source objects.

The apparatus for separating the multi-channel audio signal may separate the stereo signal into the plurality of sound source objects based on space filtering, a statistical property of a sound source, a unique time of a sound source, a frequency property of a sound source, and information about a position of a sound source. Additionally, a stereo sound source separator may separate the stereo signal into the plurality of sound sources based on a sound source separation technology used in fields of related technology.

Through such a process, the apparatus for separating the multi-channel audio signal may convert a multi-channel audio signal into a plurality of stereo signals, separate the plurality of stereo signals into a plurality of sound source objects, and output the plurality of separated sound source objects.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such to as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for separating a multi-channel audio signal, the apparatus comprising:
a multi-channel-stereo transformer to transform a multi-channel audio signal into a plurality of stereo signals; and
a stereo sound source separator to separate the plurality of stereo signals into a plurality of sound source objects.

2. The apparatus of claim 1, wherein the multi-channel-stereo transformer transforms the multi-channel audio signal into a signal of a time-frequency region, and transforms the multi-channel audio signal into the plurality of stereo signals through use of a cross correlation coefficient of a time-frequency (TF) bin.

3. The apparatus of claim 2, wherein the multi-channel-stereo transformer determines a mask to be applied to the multi-channel audio signal transformed into the time-frequency region based on the cross correlation coefficient, and generates a stereo signal through use of the determined mask.

4. The apparatus of claim 1, wherein the multi-channel-stereo transformer determines a “K” number of stereo signals to be output based on Equation 3 when a multi-channel audio signal having an “N” number of channels is input,
where
$$K = \frac{N ( N - 1 )}{2} . \qquad [ Equation 3 ]$$

5. The apparatus of claim 1, wherein the multi-channel-stereo transformer comprises:
a time-frequency transformer to transform the multi-channel audio signal into a time-frequency region;
a cross correlation coefficient calculator to calculate a cross correlation coefficient of a TF bin in the multi-channel audio signal transformed into the time-frequency region;
a mask determiner to determine a mask to be applied to the multi-channel audio signal transformed into the time-frequency region based on the cross correlation coefficient; and
a stereo signal generator to generate a stereo signal through use of the mask.

6. The apparatus of claim 1, wherein the cross correlation coefficient calculator calculates a cross correlation coefficient through use of a forgetting factor for reflecting a temporal change and the TF bin.

7. The apparatus of claim 5, wherein the mask determiner compares cross correlation coefficients of an audio channel pair, and determines an audio channel pair to which the TF bin belongs.

8. The apparatus of claim 5, wherein the mask determiner sets a value of a mask corresponding to a greatest cross correlation coefficient to “1”, and sets a value of a mask corresponding to other cross correlation coefficients to “0” from among cross correlation coefficients of an audio channel pair including a predetermined channel.

9. The apparatus of claim 5, wherein the mask determiner sets a value of a mask to a continuous value between “0” and “1” based on a size of the cross correlation coefficients of the audio channel pair including the predetermined channel.

10. The apparatus of claim 5, wherein the stereo signal generator generates a stereo signal through use of the TF bin of the multi-channel audio signal transformed into the time-frequency signal and a mask corresponding to the TF bin.

11. A method of separating a multi-channel audio signal, the method comprising:
transforming a multi-channel audio signal into a plurality of stereo signals; and
separating the plurality of stereo signals into a plurality of sound source objects.

12. The method of claim 11, wherein the transforming comprises:
transforming the multi-channel audio signal into a signal of a time-frequency region; and
transforming the multi-channel audio signal into the plurality of stereo signals through use of a cross correlation coefficient of a time-frequency (TF) bin.

13. The method of claim 12, wherein the transforming comprises:
determining a mask to be applied to the multi-channel audio signal transformed into the signal of the time-frequency region based on the cross correlation coefficient; and
generating a stereo signal through use of the determined mask.

14. The method of claim 11, wherein the transforming comprises:
transforming the multi-channel audio signal into the signal of the time-frequency region;
calculating a cross correlation coefficient of the TF bin in the multi-channel audio signal transformed into the signal of the time-frequency region;
determining a mask to be applied to the multi-channel audio signal transformed into the signal of the time-frequency region based on the cross correlation coefficient; and
generating a stereo signal through use of the mask.

15. The method of claim 14, wherein the calculating of the cross correlation coefficient comprises:
calculating the cross correlation coefficient through use of a forgetting factor for reflecting a temporal change and the TF bin.

16. The method of claim 14, wherein the determining of the mask comprises:
setting a value of a mask corresponding to a greatest cross correlation coefficient to “1”, and setting a value of a mask corresponding to other cross correlation coefficients to “0” from among cross correlation coefficients of an audio channel pair including a predetermined channel.

17. The method of claim 14, wherein the determining of the mask comprises:
setting a value of a mask to a continuous value between “0” and “1” based on a size of the cross correlation coefficients of the audio channel pair including the predetermined channel.

18. The method of claim 14, wherein the generating of the stereo signal comprises:
generating a stereo signal through use of the TF bin of the multi-channel audio signal transformed into the signal of the time-frequency region and a mask corresponding to the TF bin.
